(19) United States
(12) Patent Application Publication
(10) Pub. No.: US 2003/0196424 A1
(43) Pub. Date: Oct. 23, 2003

(54) WARREN CYCLE EXTERNAL COMBUSTION ENGINE

(76) Inventor: Edward Lawrence Warren, West Melbourne, FL (US)

Correspondence Address: Edward L. Warren, 3912 Snowy Egret Dr., West Melbourne, FL, 32904, US

(21) Appl. No.: 10/124,684

(22) Filed: Apr. 19, 2002

(51) Int. Cl. F02G 1/00; F02G 3/00; F02C 5/00

(52) U.S. Cl. 60/39.6; 60/517; 60/508

(57) ABSTRACT

The Warren cycle engine operates on the Warren Cycle, and is a two stroke, internal combustion, reciprocating, regenerated engine made up of a number of similar working units. Each working unit is comprised of cylinder 12 that is closed at one end by cylinder head 4 and contains power piston 18 that is connected to power output shaft 22. Movable wall 11 is provided to suck in the working fluid and push the exhaust out of cylinder 12. As the exhaust moves out of the engine, it gives up heat to regenerator 10. During the heating portion of the cycle movable wall 11 pushes the compressed air through regenerator 10 and recaptures the heat left by the exhaust gases. Movable wall 11 can move between power piston 18 and cylinder head 4, and means are provided to accomplish this movement at the appropriate times during the engine's operating cycle. Means are also provided for the introduction of fuel into cylinder 12 during the heating part of the cycle. The engine can be operated with complete expansion of the air-fuel charge, or it can be operated in a high power output mode, depending on the timing of the closing of cooler valve 6. In an alternate embodiment of this invention the engine operates with rotating regenerator 30. The Warren Cycle is an engine cycle where compression is adiabatic, heat is added at constant volume, expansion is adiabatic and complete, and the exhaust heat is captured and returned to the compressed air.

### BACKGROUND

1. Field of Invention

The present invention relates to a thermally regenerated, reciprocating, two stroke external combustion engine that stores the exhaust heat and returns it to the engine cycle to do work, and that has a compression ratio different from the expansion ratio.

2. Description of Prior Art

The Stirling Cycle Engine is a regenerated engine similar to the Warren Cycle Engine. It is one of the more efficient of the practical engines, but its compression ratio is the same as its expansion ratio therefore it has a problem with air volume of the heater lowering the thermal efficiency of the engine. Previous inventors tried to overcome this problem by changing the volume of the heater. Others tried by allowing the engine to expand the hot gases completely. Complete expansion was achieved by reducing the volume of the compression process so that it was different from the expansion process. Warren (Ser. No. 09/949,540 dated Sep. 10, 2001) and Warren (Ser. No. 09/036,211 dated Jan. 4, 2002) overcame the problem this way; thus recapturing any work done to the heater volume. Complete expansion was achieved by having a cooled volume much smaller than the heated volume. The present invention achieves complete expansion by holding cooler valve 6 open longer. This causes the volume of the cooled air about to be compressed to be smaller than the volume of the expanded air.

### SUMMARY

The Warren cycle engine is the mechanization of the Warren Cycle. The Warren Cycle is an engine cycle where compression is adiabatic, heat is added at constant volume, expansion is adiabatic and complete, and the exhaust heat is captured and returned to the compressed air. The result is a two stroke, external combustion, reciprocating regenerated engine made up of a number of similar working units. Each working unit is comprised of cylinder 12 that is closed at one end by cylinder head 4 and contains power piston 18 that is connected to power output shaft 22. Movable wall 11 is provided to take in the working fluid and push the exhaust out of cylinder 12. As the exhaust moves out of the engine, it gives up heat to regenerator 10. During the heating portion of the cycle movable wall 11 pushes the compressed air through regenerator 10 where the air recaptures the heat left by the exhaust gases. The air then moves on through heater 16 where it is heated further. Movable wall 11 can move between power piston 18 and cylinder head 4, and means are provided to accomplish this movement at the appropriate times during the engine's operating cycle. Varying the timing of the opening and closing of cooler valve 6 can vary the engine's power output and efficiency. In an alternate embodiment of this invention the engine operates with rotating regenerator 30.

### OBJECTS AND ADVANTAGES

The advantage of the Warren Cycle External Combustion Engine is that it can be operated so that the charge is fully expanded. This minimizes the effect of heater air volume on the thermal efficiency of the engine.

### DRAWING FIGURES

FIG. 1 shows the engine at the end of the expansion part of the cycle, and at the start of the inlet and cooling part of the cycle.

FIG. 2 shows the engine at the end of the inlet and cooling part of the cycle, and at the start of the compression part of the cycle.

FIG. 3 shows the engine at the end of the compression part of the cycle, and at the start of the heating part of the cycle.

FIG. 4 shows the engine at the end of the heating part of the cycle, and at the start of the expansion part of the cycle.

FIG. 5 shows the alternate embodiment of the engine at the end of the expansion part of the cycle, and at the start of the inlet and cooling part of the cycle.

FIG. 6 shows the alternate embodiment of the engine at the end of the inlet and cooling part of the cycle, and at the start of compression part of the cycle.

FIG. 7 shows the alternate embodiment of the engine at the end of the compression part of the cycle, and at the start of the heating part of the cycle.

FIG. 8 shows the alternate embodiment of the engine at the end of the heating part of the cycle, and at the start of the expansion part of the cycle.

### REFERENCE NUMERALS IN DRAWINGS

2 air inlet port

4 cylinder head

6 cooler valve

8 cooler

10 regenerator

11 movable wall

12 cylinder

14 plenum

16 heater

17 heater valve

18 power piston

20 connecting rod

22 power output shaft

26 cam

28 valve cams

30 rotating regenerator

32 spring

34 lower regenerator isolation valve

36 upper regenerator isolation valve

38 gearbox

### DESCRIPTION

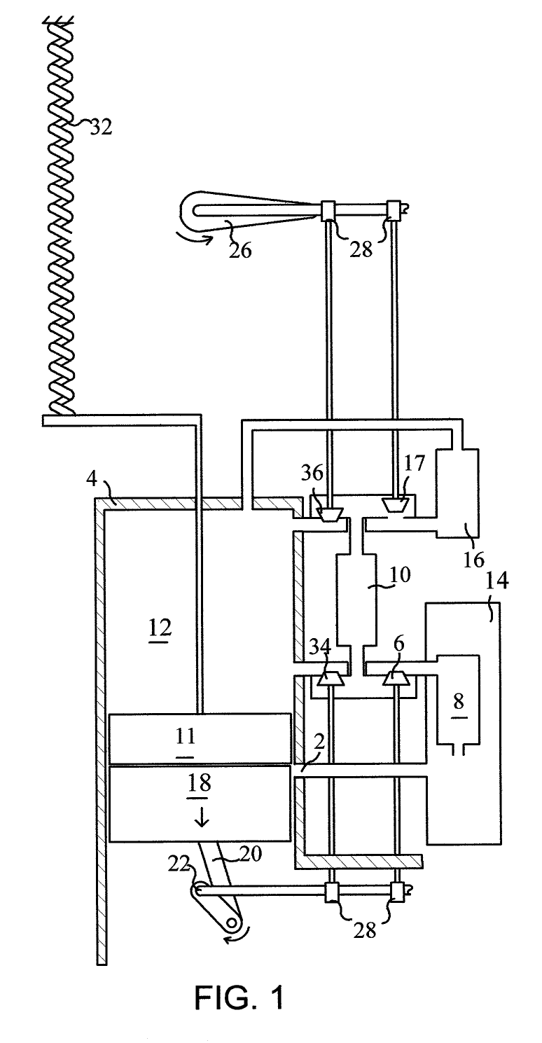

FIGS. 1 to 4—Preferred Embodiment

This invention is a two stroke, reciprocating, external combustion engine with regenerator 10, and employing a movable wall 11. The invention employs a two stroke cycle divided into four parts. The first part is the intake and the cooling part, the second is the compression part, the third is the heating part, and the fourth is the expansion part. The intake and cooling part is from about 85% of the downward travel of power piston 18 to about 15% of the travel back up (or as measured by power output shaft 22 rotation from about 135° to about (225°). The compression part is from about 15% of the travel back up of power piston 18 (225°) to about top dead center. The heating part is from about 85% of the travel back up of power piston 18 (315°) to about 15% of the downward travel of power piston 18 (45°). The expansion part is from about top dead center to about 85% of the downward travel of power piston 18 (135°). The heating part of the cycle overlaps both the end of the compression part and the start of the expansion part of the cycle. The compression ratio adjustment is part of the compression part of the cycle. The above positions are all estimates and are given for descriptive purposes only. The actual position a part of the cycle may begin or end at may be different from those set out above.

Cylinder 12 is closed at one end by cylinder head 4. Inside cylinder 12 is movable wall 11, power piston 18, and connecting rod 20. Connecting rod 20 is connected to power output shaft 22, which operates cam 26 and valve cams 28. Movable wall 11 is moved by cam 26, engine pressure forces, and spring 32.

Regenerator 10, heater 16, cooler 8, and plenum 14 are attached to cylinder 12, but separated from it by air inlet port 2, lower regenerator isolation valve 34 and upper regenerator isolation valve 36. Heater valve 17 controls the air flow out of regenerator 10 into heater 16, and cooler valve 6 controls the air flow out of regenerator 10 into cooler 8.

Air inlet port 2 allows air into cylinder 12. Cooler 8 cools the exhaust. Regenerator 10 captures exhaust heat and returns it to the compressed air. Movable wall 11 takes in air from plenum 14 and pushes exhaust out through regenerator 10 and cooler 8 during the intake and cooling part of the cycle. Movable wall 11 moves air from between power piston 18 and movable wall 11 through regenerator 10 and heater 16 into the space between cylinder head 4 and movable wall 11 during the heating part of the cycle.

Plenum 14 stores the air removed from cylinder 12 during compression ratio adjustment. Plenum 14 can be combined with cooler 8, if cooler 8 is made with a large volume so that it acts as a plenum. Both cooler 8 and plenum 14 can be shared with other cylinders.

Heater 16 heats the air. Power piston 18 along with connecting rod 20 and power output shaft 22 transfers work from the hot expanding air to a power takeoff device not shown. Cam 26 moves movable wall 11 down during the heating part of the cycle. Spring 32 is stretched by cam 26 during the heating part of the cycle and by hot expanding air during the expansion part of the cycle. During the air intake and cooling part of the cycle cam 26 moves movable wall 11 in order to push out exhaust and take in cold air. Valve cams 28 open and close cooler valve 6, heater valve 17, lower regenerator isolation valve 34, and upper regenerator isolation valve 36.

The working fluid that is expected to be employed in this invention is air. However, this working fluid could be any mixture of gases, liquids, and solids. After heating the working fluid is referred to as spent working fluid or exhaust. The air in the plenum can be maintained at any pressure.

Operation—FIGS. 1 to 4—Preferred Embodiment

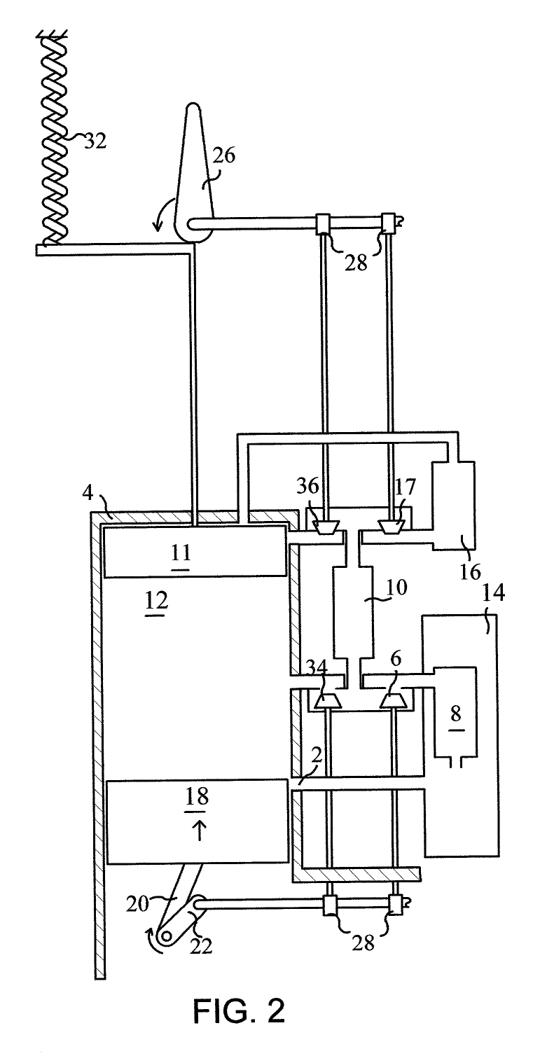

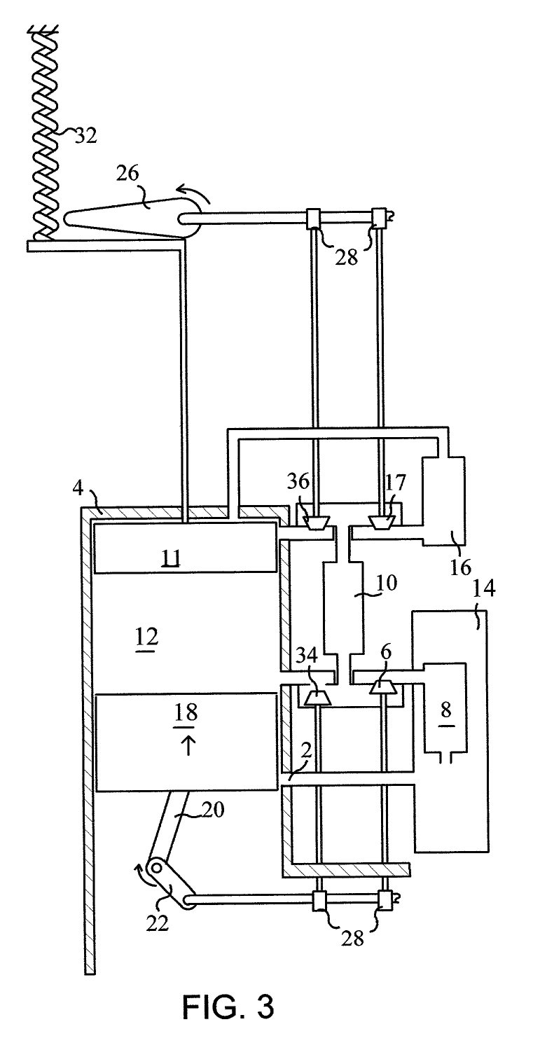

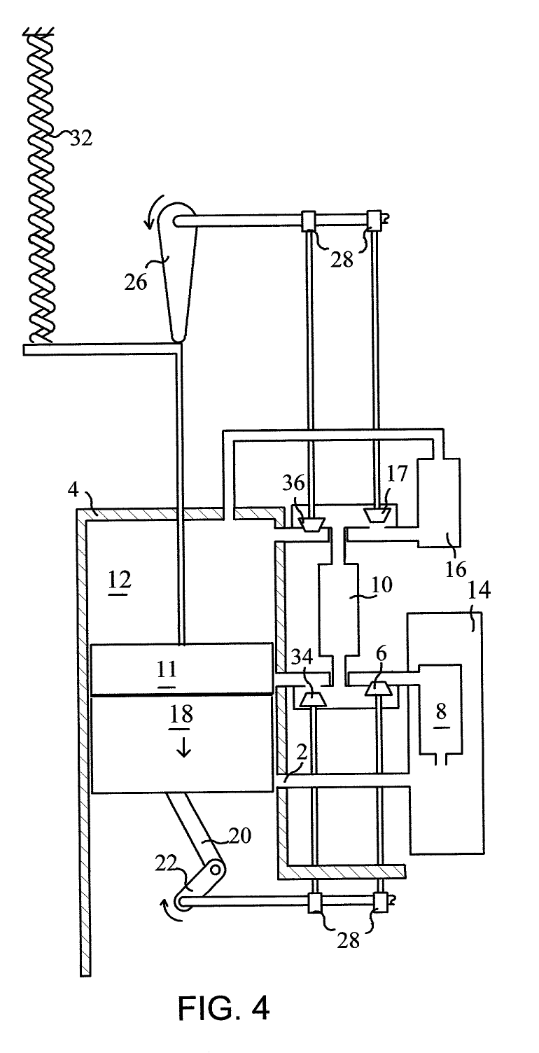

FIGS. 1 to 4 present the sequence of steps or processes occurring in a two stroke regenerative engine. The air intake and cooling part of the cycle takes place between FIGS. 1 and 2. The compression part of the cycle takes place between FIGS. 2 and 3. The heating part of the cycle takes place between FIGS. 3 and 4. The expansion part of the cycle takes place between FIGS. 4 and 1.

FIG. 1 shows power piston 18 at about 85% of downward travel (135°). The engine has completed the expansion part of the cycle and is about to start the intake and cooling part. Air inlet port 2 is covered, cooler valve 6 is closed, heater valve 17 is open, lower regenerator isolation valve 34 is closed, upper regenerator isolation valve 36 is closed, movable wall 11 is just above power piston 18, and spring 32 is stretched.

Between FIG. 1 and FIG. 2 air inlet port 2 is uncovered, cooler valve 6 opens, heater valve 17 closes, upper regenerator isolation valve 36 opens, and spring 32 urges movable wall 11 up to cylinder head 4. While movable wall 11 is moving up exhaust gases are moving through regenerator 10, heating up regenerator 10 on their way out cooler valve 6. Also while movable wall 11 is moving up, it takes fresh air into cylinder 12 through air inlet port 2. Power piston 18 continues down to the bottom of cylinder 12 and comes up again to about 15% of upward travel of power piston 18 (225°). Lower regenerator isolation valve 34 opens, and upper regenerator isolation valve 36 closes.

In FIG. 2, there is a maximum charge of fresh air between cylinder head 4 and power piston 18 which is at about 15% of its upward travel (225°). Air inlet port 2 is covered, cooler valve 6 is open, heater valve 17 is closed, lower regenerator isolation valve 34 is open, and upper regenerator isolation valve 36 is closed.

Between FIG. 2 and FIG. 3 power piston 18 continues to move up in cylinder 12, and cooler valve 6 closes. The sooner cooler valve 6 closes the higher the compression ratio, and the later cooler valve 6 closes the lower the compression ratio. The setting of when cooler valve 6 closes determines the compression ratio of the engine. The compression ratio of the engine does not have to be the same as the expansion ratio, and the engine can be operated to complete expansion of the heated air. After cooler valve 6 closes power piston 18 continues to move up in cylinder 12 and will come up to about 85% of its upward travel (315°).

In FIG. 3, power piston 18 is at about 85% of its upward travel (315°). Air inlet port 2 is covered, cooler valve 6 is closed, heater valve 17 is closed, lower regenerator isolation valve 34 is open, upper regenerator isolation valve 36 is closed, and movable wall 11 is still adjacent to cylinder head 4.

Between FIG. 3 and FIG. 4 heater valve 17 opens, power piston 18 continues up to top dead center and comes down again to about 15% of downward travel (45°). Movable wall 11 is urged down by cam 26, spring 32 is stretched, and compressed air is moved from the space between movable wall 11 and power piston 18 through regenerator 10, where it heats up, and through heater 16 where it heats up further. The hot air then goes into the space between movable wall 11 and cylinder head 4.

In FIG. 4, power piston 18 is at about 15% of its downward travel (45°), movable wall 11 is adjacent to power piston 18, and both are being forced down by gas pressure forces. Air inlet port 2 is covered, cooler valve 6 is closed, heater valve 17 is open, lower regenerator isolation valve 34 is open, upper regenerator isolation valve 36 is closed, and spring 32 is being stretched.

Between FIG. 4 and FIG. 1 power piston 18 and movable wall 11 move down to about 85% of power piston's 18 downward travel (135°), power output takes place, lower regenerator isolation valve 34 closes, and spring 32 stretches further.

The cycle repeats.

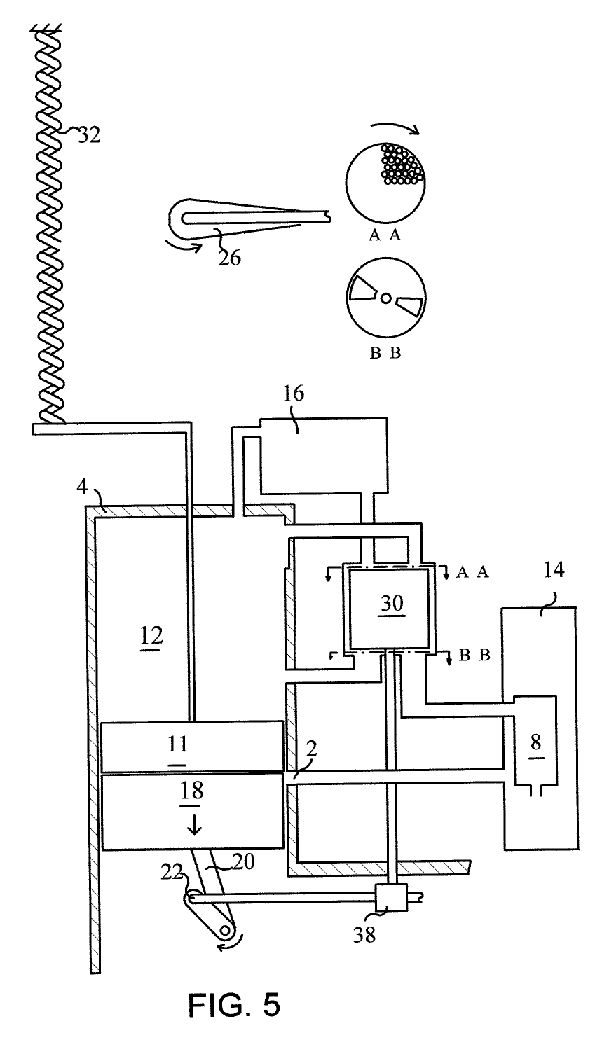

FIGS. 5 to 8—First Alternate Embodiment of the Invention

Cylinder 12 closed at one end by cylinder head 4. Inside cylinder 12 is movable wall 11, power piston 18, and connecting rod 20. Connecting rod 20 is connected to power output shaft 22, which operates cam 26 and gearbox 38. Movable wall 11 is moved by cam 26, engine pressure forces, and spring 32.

Attached to cylinder 12 are rotating regenerator 30, heater 16, cooler 8, and plenum 14. As rotating regenerator 30 rotates it directs the flow out of cylinder 12 into heater 16 or cooler 8 depending on where the holes in rotating regenerator 30 line up.

Air inlet port 2 allows air into cylinder 12. Cooler 8 cools the exhaust gases. Rotating regenerator 30 captures exhaust heat and returns it to the compressed air. Movable wall 11 during the intake and cooling part of the cycle takes in air from plenum 14 and pushes exhaust out through rotating regenerator 30 and cooler 8. Movable wall 11 during the heating part of the cycle moves air from between power piston 18 and movable wall 11 through rotating regenerator 30 and heater 16 into the space between cylinder head 4 and movable wall 11.

Plenum 14 stores the air removed from cylinder 12 during compression ratio adjustment. Plenum 14 can be combined with cooler 8 if cooler 8 is made with a large volume so that it acts as a plenum.

Heater 16 heats the air. Power piston 18 along with connecting rod 20 and power output shaft 22 transfers work from the hot expanding air to a power takeoff device not shown. Cam 26 moves movable wall 11 down during the heating part of the cycle. Spring 32 is stretched by cam 26 during the heating part of the cycle and by hot expanding air during the expansion part of the cycle. During the air intake and cooling part of the cycle it moves movable wall 11 so as to push out exhaust and take in cold air. Gearbox 38 rotates rotating regenerator 30.

Operation—FIGS. 5 to 8—First Alternate Embodiment of the Invention

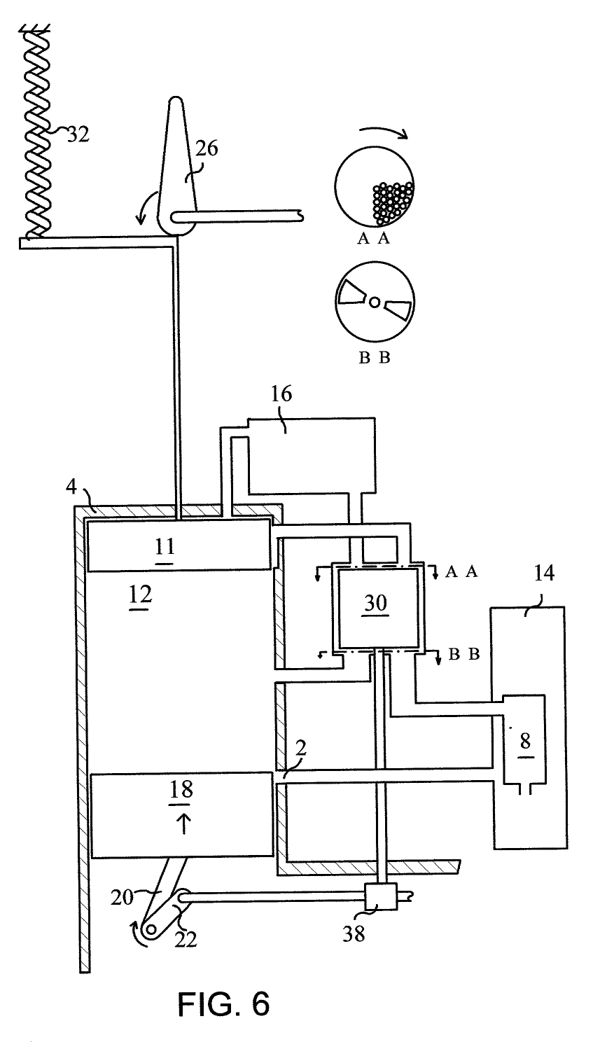

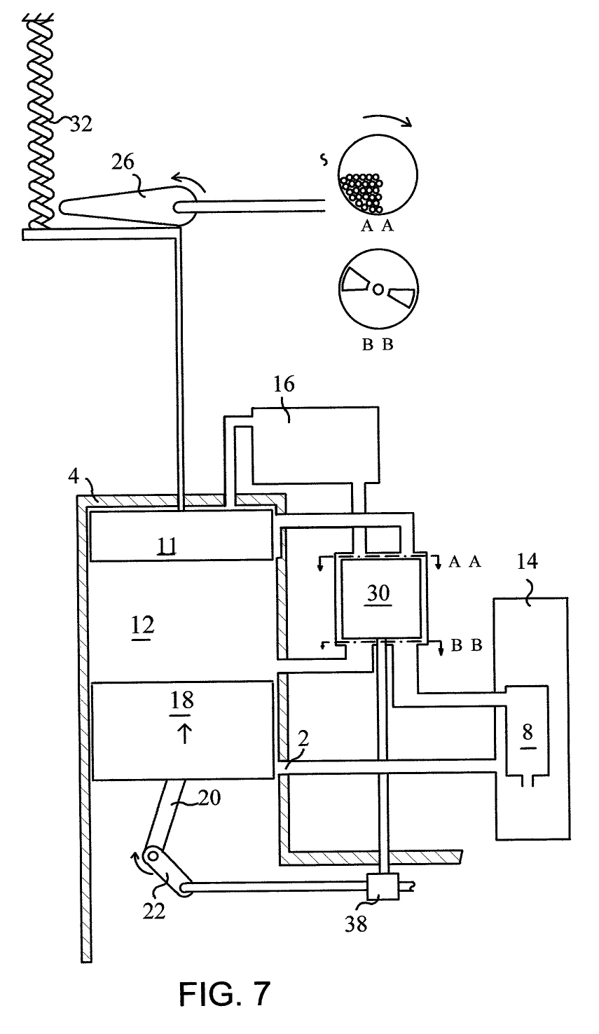

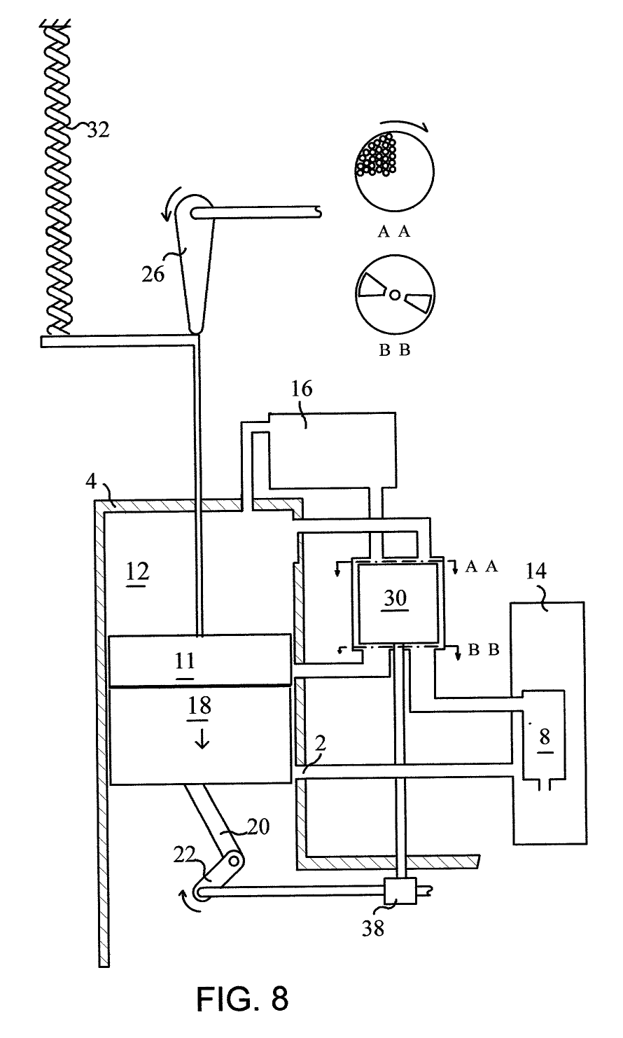

FIGS. 5 to 8 present the sequence of steps or processes occurring in a two stroke regenerative engine. The air intake and cooling part of the cycle takes place between FIGS. 5 and 6. The compression part of the cycle takes place between FIGS. 6 and 7. The heating part of the cycle takes place between FIGS. 7 and 8. The expansion part of the cycle takes place between FIGS. 8 and 5.

FIG. 5 shows power piston 18 at about 85% of downward travel (135°). The engine has completed the expansion part of the cycle and is about to start the intake and cooling part. Air inlet port 2 is covered, the holes in rotating regenerator 30 are not lined up with any openings, movable wall 11 is just above power piston 18, and spring 32 is stretched.

Between FIG. 5 and FIG. 6 air inlet port 2 is uncovered, the holes in rotating regenerator 30 line up so as to allow air to pass through rotating regenerator 30 to cooler 8, and spring 32 urges movable wall 11 up to cylinder head 4. While movable wall 11 is moving up exhaust gases are moving through rotating regenerator 30, heating up rotating regenerator 30 on their way through. Also while movable wall 11 is moving up, it takes fresh air into cylinder 12 through air inlet port 2. Power piston 18 continues down to the bottom of cylinder 12 and comes up again to about 15% of upward travel of power piston 18 (225°).

In FIG. 6, there is a maximum charge of fresh air between cylinder head 4 and power piston 18 which is at about 15% of its upward travel (225°). Air inlet port 2 is covered.

Between FIG. 6 and FIG. 7 power piston 18 continues to move up in cylinder 12, the longer the holes in rotating regenerator 30 line up allowing air to pass through rotating regenerator 30 to cooler 8, the lower the compression ratio. The placement of the holes in rotating regenerator 30 determines the compression ratio of the engine. The compression ratio of the engine does not have to be the same as the expansion ratio, and the engine can be operated to complete expansion of the heated air. When the holes in rotating regenerator 30 no longer line up, compression begins, and power piston 18 continues to move up in cylinder 12 and will come up to about 85% of its upward travel (315°).

In FIG. 7, power piston 18 is at about 85% of its upward travel (315°). Air inlet port 2 is covered, and movable wall 11 is still adjacent to cylinder head 4.

Between FIG. 7 and FIG. 8 the holes in rotating regenerator 30 line allowing air to pass through rotating regenerator 30 to heater 16, power piston 18 continues up to top dead center and comes down again to about 15% of downward travel (45°). Movable wall 11 is urged down by cam 26, spring 32 is stretched, and compressed air is moved from the space between movable wall 11 and power piston 18 through rotating regenerator 30, where the air heats up, and through heater 16 where the air heats up further. The hot air then goes into the space between movable wall 11 and cylinder head 4.

In FIG. 8, power piston 18 is at about 15% of its downward travel (45°), movable wall 11 is adjacent to power piston 18, and both are being forced down by gas pressure forces. Air inlet port 2 is covered, and spring 32 is being stretched.

Between FIG. 8 and FIG. 5 power piston 18 and movable wall 11 move down to about 85% of power piston's 18 downward travel (135°), power output takes place, and spring 32 stretches further.

The cycle repeats.

### CONCLUSION

The advantage of the Warren Cycle External Combustion Engine is that it can be operated so that the charge is fully expanded. This minimizes the effect of heater air volume on the thermal efficiency of the engine.

I claim:

1. A two stroke, external combustion, reciprocating engine having a cooler, a means to store the air during compression ratio adjustment, and a number of similar working units, each working unit comprising:
a) a cylinder, closed at one end by a cylinder head and containing a movable power piston which moves in a reciprocating manner and is connected to a power output shaft;
b) a movable wall located within said cylinder and between said power piston and said cylinder head, said movable wall can be moved between said power piston and said cylinder head;
c) an air inlet means;
d) a heat storage means;
e) a heater;
f) a means to direct the air flow from said cylinder through said thermal regenerator, through said heater, and back into said cylinder at predetermined times during the cycle;
g) a means to direct the air flow from said cylinder through said thermal regenerator, through said cooler, to said plenum at predetermined times during the cycle;
h) an actuator means for moving said movable wall during predetermined times during the engine's operating cycle.

1. An engine as recited in claim 1 wherein the hot air is expanded to the minimum engine pressure.

2. An engine as recited in claim 1 wherein said air inlet means is a port in the side of the cylinder.

3. An engine as recited in claim 1 wherein said heat storage means is a thermal regenerator.

4. An engine as recited in claim 1 wherein said means to store the air during compression ratio adjustment is a plenum.

5. An engine as recited in claim 1 wherein said means to store the air during compression ratio adjustment is a large volume cooler.

6. An engine as recited in claim 1 wherein said means to direct the air flow from said cylinder through said heat storage means, through said cooler, through said plenum, and back into said cylinder at predetermined times during the cycle is a set of valves, and said means to direct the air flow from said cylinder through said heat storage means, through said heater, and back into said cylinder at predetermined times during the cycle is a set of valves.

7. An engine as recited in claim 1 wherein said actuator means for moving said movable wall during predetermined times during the engine's operating cycle is a cam and spring combination.

8. An engine as recited in claim 1 wherein said heat storage means is capable of rotating; further, said means to direct the air flow from said cylinder through said heat storage means, through said cooler, through said plenum, and back into said cylinder at predetermined times during the cycle; and said means to direct the air flow from said cylinder through said heat storage means, through said heater, and back into said cylinder at predetermined times during the cycle is a function of said a heat storage means.

9. A process for operating the engine of claim 1 having the following steps:
a) from when said power piston uncovers said air inlet port and moves through its bottom dead center position and moves back up to said air inlet port; air intake, exhaust heat capture by said a heat storage means, and cooling occurs;
b) after said power piston covers said air inlet port, said power piston continues to move up cooling said air and storing said air in said plenum until the engine compression ratio is adjusted;
c) air in said cylinder is compressed;
d) as said power piston approaches top dead center position near the conclusion of the compression stroke, said movable wall moves away from its position adjacent to said cylinder head toward said power piston, compressed air is forced from below said movable wall through said heat storage means and through said heater to above said movable wall, as the compressed air moves through said heat storage means and said heater it heats up;
e) said movable wall moves to the top of said power piston while said power piston continues its expansion stroke;
f) the cycle repeats.

10. A process for operating the engine of claim 1 having the following steps:
a) air intake and cooling,
b) the capture of exhaust heat by said a heat storage means during exhausting,
c) removal of air to adjust the compression ratio,
d) compression at near adiabatic conditions,
e) heat added from said a heat storage means and from said heater at near constant volume,
f) expansion at near adiabatic conditions,
g) the cycle repeats.

11. An engine as recited in claim 1 wherein the expansion ratio is different from the compression ratio.
